(19) United States
(12) Patent Application Publication
(10) Pub. No.: US 2014/0336993 A1
(43) Pub. Date: Nov. 13, 2014

(54) MULTIPURPOSE CALCULATION COMPUTING DEVICE

(71) Applicants: Laura Grigori, Paris (FR); Frédéric Nataf, Paris (FR); Pawan Kumar, Shillong (IN)

(72) Inventors: Laura Grigori, Paris (FR); Frédéric Nataf, Paris (FR); Pawan Kumar, Shillong (IN)

(73) Assignees: INRIA INSTITUT NATIONAL DE RECHERCHE EN INFORMATIQUE ET EN AUTOMATIQUE, Le Chesnay (FR); Universite Pierre et Marie Curie (Paris 6), Paris (FR); CENTRE NATIONAL DE LA RECHERCHE SCIENTIFIQUE (C.N.R.S), Paris (FR)

(21) Appl. No.: 13/824,994

(22) PCT Filed: Sep. 15, 2011
(86) PCT No.: PCT/FR2011/052128

§ 371 Date: Aug. 5, 2013

(30) Foreign Application Priority Data
Sep. 17, 2010 (FR) 10 03716

(51) Int. Cl. G06F 17/50; G06F 17/16

(52) U.S. Cl. CPC G06F 17/5009; G06F 17/16
USPC 703/2

(57) ABSTRACT

A multipurpose computing device includes a solver receiving a working matrix and an initial matrix corresponding to a system of equations and residual data; and an adapter receiving the initial matrix as well as a filtering matrix and calculates a working matrix corresponding to an equation system solved by the solver. The working matrix checks a stability condition with the initial matrix, comprising a comparison of two matrix products including the filtering matrix or the transpose thereof, and the initial matrix and the working matrix, respectively. The adapter renumbers the initial matrix and the filtering matrix in order to produce a modified matrix and a modified filtering matrix using an ordering rule that is a function of a dependency condition, and recursively calculates the working matrix representation with these matrices. The solver works recursively on the working matrix to provide a solution without inverting the initial matrix.

### CROSS-REFERENCE TO RELATED APPLICATIONS

The present application is a National Stage of International Application No. PCT/FR2011/052128 filed Sep. 15, 2011, which published as WO 2012/035272 on Mar. 22, 2012. The '128 PCT claims priority to French Application 10 03716, filed Sep. 17, 2010. All of the above references are incorporated herein by reference in their entirety.

### FIELD OF THE INVENTION

The invention relates to the modeling and simulation of complex physical systems.

### BACKGROUND

In many fields of modern physics, the equations which govern a physical phenomenon cannot be solved theoretically. This is notably the case of all the problems which relate to fluid mechanics, for example in the modeling of the operation of an oil field.

In these situations, the differential equations are solved numerically, i.e. by discretizing the general equations, according to particular parameters of the simulation.

These discrete systems are solved by using matrices of very large size, in which the discretized equations form the bases of the systems. These base matrices are difficult to invert.

So-called direct methods such as the Gauss elimination make it possible to resolve these linear systems without inversion. But these direct methods are very greedy in terms of calculation time and memory use, which makes them unusable in practice for very large matrices.

In order to solve this problem, iterative methods are widely used today. These methods, for example the one called “GMRES”, are based on Krylov sub-spaces. With the purpose of accelerating convergence of the iterative methods, “pre-conditioners” have been created. These are elements which calculate a matrix close to the base matrix, and the inverse of which may be effectively applied to an arbitrary vector.

Pre-conditioners are of interest, but pose problems with certain vectors for which they do not reliably reproduce the base matrix. In order to solve this problem, pre-conditioners “fulfilling a filtering property” have been developed, which have the particularity of being an accurate picture of the base matrix for a particular selected vector.

To this day, the methods for producing pre-conditioners satisfying a filtering condition require base matrices having a very specific form, which strongly limits the use and the utility of the pre-conditioners fulfilling a filtering property.

The invention will improve the situation.

### SUMMARY

For this purpose, the invention proposes a versatile calculation computer device of the type including a calculator-solver, laid out in order to receive a working matrix representation and an initial matrix representation corresponding to a system of equations, as well as data of residues, and for providing a solution of the system of equations from data of residues, an adapter, laid out for receiving an initial matrix representation corresponding to a system of equations to be processed, as well as a filtering matrix representation for this system of equations, and laid out for calculating a working matrix representation corresponding to a system of equations which may be solved by the calculator-solver. The working matrix representation being forced to meet with the initial matrix representation, a stability condition comprising an expression for comparing two matrix products both including said filtering matrix representation or its transpose and respectively including the initial matrix representation and the working matrix representation.

The adapter is arranged on the one hand to renumber the initial matrix representation and the filtering matrix representation to produce a modified matrix representation and a modified filtering matrix representation according to an ordering rule laid out so as to associate blocks of the matrix of the initial matrix representation as a function of a dependence condition, and on the other hand for recursively calculating the working matrix representation from the modified matrix representation and said modified filtering matrix representation, while the calculator-solver is arranged to work recursively on the working matrix representation so as to provide a solution for the system of equations of the initial matrix representation, without complete inversion thereof.

Said recursive calculation of the adapter includes calculating the working matrix representation in the form of a matrix product PQR:
where P is the sum of a diagonal matrix calculated from an auxiliary matrix and an approximation matrix on the one hand, and a block lower triangular matrix on the other hand whereof only the non-diagonal terms of the last raw of blocks are non-zero and are equal to the terms of the same index in the modified matrix representation,
where Q is the inverse of the diagonal matrix,
where R is the sum between the diagonal matrix and a block upper triangular matrix whereof only the non-diagonal terms of the last column of blocks are non-zero, and are equal to the terms of the same index in the modified matrix representation,
the auxiliary matrix being a block diagonal matrix, whereof each block with index i is: defined equal to the diagonal block of index i of the modified matrix representation when that block does not verify the recursion condition, and otherwise calculated by a recursive call to the adapter with the diagonal block with index i of the modified matrix representation as modified matrix representation and with a subset of the modified filtering matrix representation drawn from the index i as modified filtering matrix representation.
the approximation matrix is a block diagonal matrix whereof the last block is zero, and whereof each non-zero block of index i is forced to verify, with the diagonal block of index i of the auxiliary matrix, an equivalence condition, comprising a comparison expression of two matrix products both respectively including said modified filtering matrix representation or its transpose and respectively a block of the block upper triangular matrix or a block of the block lower triangular matrix, and respectively including the inverse of said diagonal block with index i of the auxiliary matrix, and said block with index i of the approximation matrix,
the diagonal blocks of the diagonal matrix being equal to the blocks with the same index of the auxiliary matrix, except for the last one, which is defined as the difference between the last block of the auxiliary matrix and the sum for a non-zero index k smaller than the number of diagonal blocks of the modified matrix representation of matrix products in form WXY, where W is the non-zero block of the k-th column of the block lower triangular matrix, X is the k-th block of the approximation matrix, and Y is the non-zero block of the k-th row of the block upper triangular matrix.

The invention also relates to a method having the steps of:
(a) receiving an initial matrix representation corresponding to a system of equations to be processed and a filtering matrix representation,
(b) calculating a working matrix representation meeting with the initial matrix representation, a stability condition comprising an expression for comparing two matrix products both including said filtering matrix representation or its transpose, and respectively including the initial matrix representation and the working matrix representation,
(c) receiving data of residues, and solving the system of equations defined by the initial matrix representation, from the data of residues, the working matrix representation and the initial matrix representation.

The operation b) includes:

b1) renumbering the initial matrix representation and the filtering matrix representation to produce a modified matrix representation and modified filtering matrix representation, and recursively calculating the working matrix representation from the modified matrix representation and the filtering representation,
b2) for each diagonal block of the modified matrix representation:
b2a) determining whether the current diagonal block of the modified matrix representation verifies a recursion condition,
b2b) if the recursion condition is verified, calculating a current block of an auxiliary matrix by reiterating the operation b) with the current diagonal block as modified matrix representation, and with a subset of the modified filtering matrix representation drawn from the index i (tᵢ) as modified filtering matrix representation,
b2c) if the recursion condition is not verified, defining the current block of the auxiliary matrix as equal to the current diagonal block,
   b3) calculating blocks of a diagonal approximation matrix whereof each non-zero block with index i is forced to verify, with the diagonal block with index i of the auxiliary matrix, an equivalence condition, comprising a comparison expression of two matrix products both respectively including said modified filtering matrix representation or its transpose and respectively a block of a block upper triangular matrix or a block of a block lower triangular matrix, and respectively including the inverse of said diagonal block with index i of the auxiliary matrix, and said block with index i of the approximation matrix, said block upper triangular matrix and block lower triangular matrix being such that only the non-diagonal blocks of the last column and respectively non-diagonal blocks of the last row are non-zero and defined equal to the corresponding blocks of the modified matrix representation,
   b4) calculating a block diagonal matrix whereof the blocks are equal to the blocks of the same index of the auxiliary matrix, except for the last one, which is defined as the difference between the last block of the auxiliary matrix and the sum for a non-zero index k smaller than the number of diagonal blocks of the modified matrix representation of matrix products in form XYZ where X is the non-zero block of the k-th column of the block lower triangular matrix, Y is the k-th block of the approximation matrix, and Z is the non-zero block of the k-th row of the block upper triangular matrix, and
   b5) calculating the working matrix representation from a matrix product whereof a first term is equal to the sum of the block lower triangular matrix and the matrix of operation b4), a second term is the inverse of the matrix of operation b4), and a third term is equal to the sum of the block upper triangular matrix and the matrix of operation b4).

The operation c) includes working recursively on the working matrix representation so as to provide a solution for the system of equations of the initial matrix representation without complete inversion thereof.

### BRIEF DESCRIPTION OF THE DRAWINGS

Other features and advantages of the invention will become better apparent upon reading the description which follows, drawn from examples given as an illustration and not as a limitation, drawn from drawings wherein:

FIG. 1 represents a schematic view of a modeling and simulation system according to the invention,

FIG. 2 illustrates a simplified flow diagram of a modeling and simulation operation by means of the system of FIG. 1,

FIG. 3 illustrates a simplified flow diagram of an operation of FIG. 2,

FIG. 4 illustrates an exemplary matrix obtained after a first numbering operation according to an optional operation of FIG. 3,

FIG. 5 illustrates an exemplary matrix obtained after a second numbering operation according to an operation of FIG. 3, and

FIG. 6 illustrates an exemplary function of calculation of a preconditioner according to an operation of FIG. 3 from a result obtained after the operation whereof result is represented in FIG. 5.

### DETAILED DESCRIPTION

The drawings and the description hereafter essentially contain elements with certainty. They may therefore not only be used for better understanding the present invention, but also for contributing to its definition, if necessary.

Further, the detailed description is expanded with Annex A, which gives the formulation of certain mathematical formulae applied within the scope of the invention. This annex is set apart with a purpose of clarification, and for convenience of references. It is an integral portion of the description, and may therefore not only be used for better understanding the present invention but also for contributing to its definition, if necessary.

Modeling and simulation of physical systems have become major issues. For example, in the operation of a hydrocarbon well, there is a first phase during which the oil flows out naturally. Next, gradually as the pressure decreases, it becomes necessary to act in order to recover the oil.

For this, it is possible, for example, to use a flow of water, which is introduced into the well in order to cause the pressure to increase again and cause a splashing up of the oil. But these hazardous operations require intimate knowledge of the well and of the reactions of the latter under these circumstances.

The equations which determine this physical problem are very complex, and for most of them only assume solutions by discretization and a numerical method of the finite difference or finite volume type.

The thereby discretized problems may then be summarized in formula (10) of Annex A, wherein A is the base matrix which defines the discretized system of equations, X is the vector which is sought and Y is the known result vector.

This type of problem is well known in algebra, and the question is to find the inverse matrix of A in order to calculate X. But inversion of matrices is a complex problem, which monopolizes computing powers which increase exponentially with the size of the matrix to be inverted.

For this, iterative methods based on Krylov sub-spaces, like GMRES, are widely used today. In order to accelerate the convergence of these methods, “pre-conditioners” have been proposed. Pre-conditioners are matrices which give the possibility of rapidly approaching the inverse matrix of A. By using the pre-conditioner M, the iterative method solves the linear system

M⁻¹ A x=M⁻¹ b.

In this solving method, operations of the type M⁻¹ v and A v wherein v is a vector, are calculated, without explicitly calculating the inverse of M.

As this was explained above, there exists a particular class of pre-conditioners, pre-conditioners which satisfy a filtering property.

Pre-conditioners satisfying a filtering property have the additional advantage of behaving in the same way as the matrix A for a given vector, as this is explained in formula (20) of Annex A, wherein M is the pre-conditioner, and t the selected vector.

To this day, the most known methods for producing a preconditioner satisfying a filtering property use matrices A which are tridiagonal blockwise. This considerably restricts their field of application.

Further, the methods for calculating these pre-conditioners are mostly sequential methods, which makes them rapidly prohibitory in terms of computing costs, and are therefore not very used in practice. Indeed, only matrices from a structured meshing may be processed in parallel, which considerably restricts their field of application.

The Applicants have also designed a method using any type of matrix A to produce a pre-conditioner satisfying a filtering property. This method is based on the factoring of the matrix A in the form of a product LDU. However, the parallelization of the calculations within this method can be improved, and this method is not interleaved.

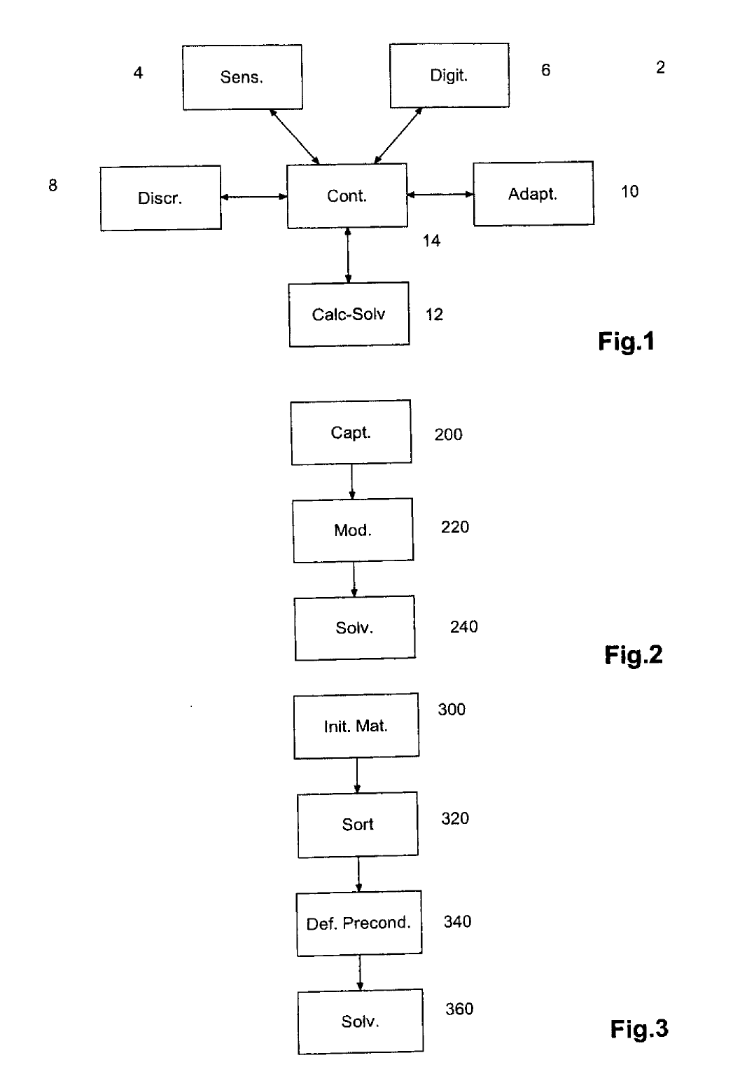

FIG. 1 represents a versatile calculation computer device 2 according to examples of the invention. The device 2 includes a set of sensors 4, a digitizer 6, a discretizer 8, an adapter 10, a calculator-solver 12, and a driver 14 which controls them.

In the example described herein, the set of sensors 4 are used for obtaining the data which constrain the physical system to be modeled, and the digitizer 6 is used for transforming these analog data in order to inject them into theoretical equations.

These elements are, so to speak, unconcerned about the problems solved by the invention: they are used for defining the framework for its practical application. Thus, also, their making may be very diverse.

The discretizer 8 is called by the driver 14 in order to discretize the theoretical equations made distinct with actual data, and for drawing therefrom a system of linear equations.

This system generally has a very large size, and its lines form the matrix A. There again, this element may be achieved in many different ways.

Finally, the adapter 10 and the calculator 12 are called by the driver 14 for calculating the pre-conditioner and for drawing up a solution corresponding to a particular situation for which modeling is sought. In this case, the data on the “right side” of the equation involving the matrix A are also called residue data, with reference to Newton methods.

The driver 14 may call the adapter 10 and the calculator 12 for having this particular solution develop per successive time steps and thus giving a simulation of the evolution of the modeled physical system.

According to a further example, the adapter 10 is called only once by the driver 14 for calculating a pre-conditioner which is used for the whole period of the simulation, and the result calculated by the calculator 12 for a given time step is used as an input for the next time step.

According to another example, the adapter 10 may be selectively called by the driver 14, depending on the development of the simulation, notably if the latter tends to modify the original system of the matrix A.

Here again, the simulation techniques are diverse.

FIG. 2 shows a simplified flow diagram showing the operations summarized above. In an operation 200, the set of sensors 4 is called in order to measure all the parameters required for the simulation, In an operation 220, the digitizer 6 and the discretizer 8 are called for modeling the system numerically, with the measurements drawn from the operation 200. In an operation 240, the adapter 10 and the calculator 12 are called in order to carry out the simulation as such.

FIG. 3 shows a simplified flow diagram of the operation 240.

In an operation 300, the driver 14 transmits the matrix A drawn from the operation 220 to the adapter 10.

In an operation 320, the adapter 10 re-numbers the elements of the matrix A in order to allow subsequent processing in parallel.

Renumbering means rewriting the equations that define the matrix A, so as to give it a form that is easier to manipulate. In practice, this amounts to determining a permutation matrix, which makes it possible to go from the original form of the matrix A to its renumbered form.

This operation 320 may be carried out in several ways, for example, by nested dissection or by partitioning into several independent domains which may also overlap and have a recursive sub-partition.

Such overlapping slightly increases the computing costs but provides better convergence rates and superior robustness as this is achieved in the Schwartz method. The adapter 10 thus gives the possibility of obtaining a re-ordered matrix B which includes blocks of zeroes.

Next, in operation 340, the adapter 10 processes the matrix A, either re-ordered or not, in order to draw therefrom a representation of a pre-conditioner M satisfying a filtering property. Finally, in operation 360, the driver 14 calls the calculator 12 with the representation of the pre-conditioner M in order to achieve the simulation.

The device formed by the adapter 10, the calculator 12, and the driver 14, therefore allows calculation of a representation of a pre-conditioner verifying a filtering property for any matrix A as an input, and massive parallelization of the calculations related to the pre-conditioner.

The Applicants have developed a device implementing a pre-conditioner and an interleaved calculation method for a representation of that pre-conditioner that are particularly suitable for the parallelization of the calculations.

To better understand this, a more detailed explanation should first be provided of one example of the operation 320. This example here will be based on the case of a two-level nested dissection.

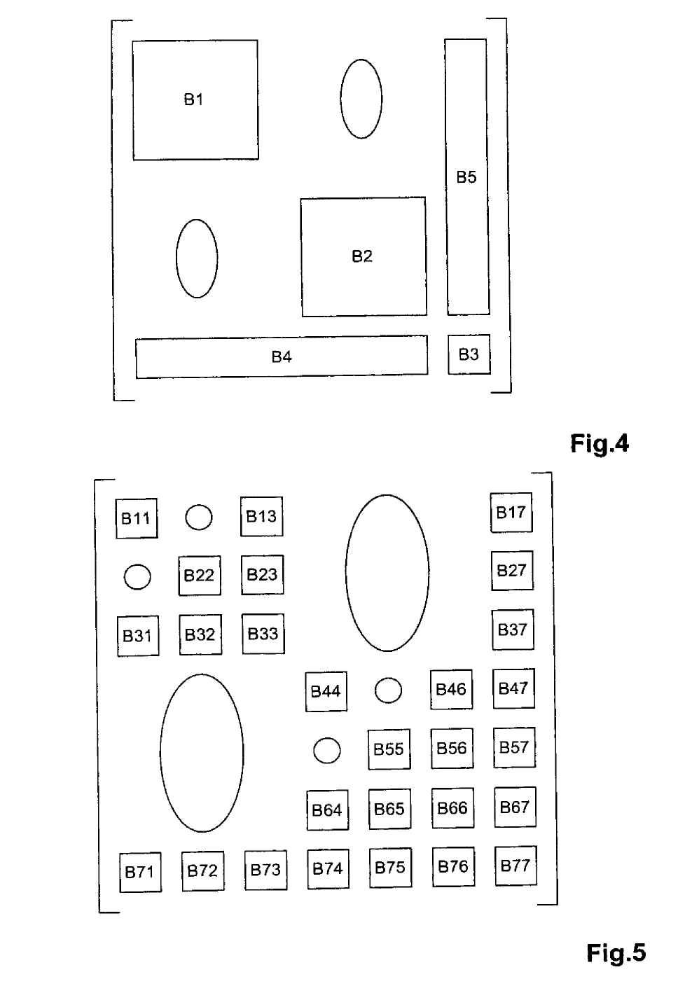

In this type of operation, the matrix A is modified to give it the form of an “arrow” matrix B. To that end, the matrix A is renumbered a first time to give it the form of the matrix shown in FIG. 4, then the sub-matrices of the matrix of FIG. 4 are in turn renumbered in the same way.

The matrix of FIG. 4 includes three diagonal blocks B1, B2 and B3, two blocks B4 and B5 respectively along the bottom and right edges of the matrix B, and is zero elsewhere. This renumbering of the matrix A is possible due to its low density. The same renumbering is done on the vector x, y and t.

Once the matrix of FIG. 4 has been calculated, it is possible to reapply that same renumbering to the blocks B1 and B2 and B3. FIG. 5 shows the matrix B in which the renumbering has been done on the blocks B1 and B2. It will be noted in this figure that the block B3 of FIG. 4 is the block B77 FIG. 5, and that the blocks B4 and B5 of FIG. 4 respectively correspond to the blocks B71 to B76 and the blocks B17 to B67 of FIG. 5.

Once the operation 320 is complete, the matrix A has therefore been renumbered such that it has the form represented in FIG. 4. However, each diagonal block of FIG. 4 also has the same arrow form as the matrix A, as illustrated in FIG. 5.

The reordering operation of operation 320 may again be repeated on the diagonal blocks of FIG. 5, then on the resulting diagonal blocks, until it no longer produces independent domains.

This property is important, since it is shown below, a diagonal block may be replaced by a pre-conditioner that approximates it according to the method of the invention, which makes it possible to interleave the calculations, and thereby reduce the size of the working elements, while increasing the parallelization of the calculations.

The calculation of the pre-conditioner M starts from a matrix A in the form of formula (30) of Annex A. Formulas (40), (50) and (60) of annex A provide the composition of the respective elements making up the matrix A.

This matrix form corresponds to that of the matrix B of FIG. 4, form which is found for all of the diagonal blocks for which the renumbering has been done as explained above.

The Applicants discovered that from a matrix respecting formula (30) and its exact factoring according to formula (70), it is possible to construct, by similarity, a pre-conditioner M according to formula (80) of annex A.

To that end, the matrix S is defined similarly to the matrix T by formula (90) of annex A, where the matrix F represents an approximation of the inverse of the matrix T. The compositions of the matrices F and C of formula (90) are respectively given in formulas (100) and (110) of annex A.

For the pre-conditioner M to satisfy equation (20), it suffices for the matrices S, F and C to verify the two conditions expressed in formula (120) of annex A. The development of these two conditions from formulas (100) and (110) leads to the conditions expressed in formula (130) of annex A.

The first condition is fundamental, since it expresses the fact that the matrix C must satisfy the filtering condition relative to the matrix D. In this way, it is possible to choose C=D.

But when a diagonal block Dᵢᵢ has the same arrow form as the matrix of formula (30), it is also possible to apply the method again, and to use a pre-conditioner Cᵢᵢ that approximates Dᵢᵢ and that meets the filtering condition. Thus, this first condition makes it possible to interleave the population of the pre-conditioner.

The second condition makes it possible to simplify the condition of formula (70). In fact, therein, the matrix T is defined relative to its inverse, which makes it complex to determine. The use of the matrix F makes it possible to eliminate this problem. The fact that F verifies the second condition of formula (130) can be seen as an equivalence condition for each block Fᵢᵢ with the inverse of the diagonal block Cᵢᵢ.

Formula (140) is a first calculation mode for the matrix F, and expresses the fact that it groups together terms Fᵢᵢ that approximate the diagonal block Cᵢᵢ⁻¹ for the N-th filtering component t. J-th component refers to the set of elements of t whereof the indices correspond to the indices of the matrix Dⱼⱼ. For example, if the matrices D₁₁ to D₍ⱼ₋₁₎₍ⱼ₋₁₎ have p columns, and the matrix Dⱼⱼ has q columns, then the j-th component includes all of the index terms included between p+1 and p+q.

When the vector (U_{IN}t_{N}) does not have any zero component, the calculation of Fᵢᵢ is easy. Formula (140) can account for cases where this vector has zero components.

The Applicants have also discovered another calculation for the matrix Fᵢᵢ, in which the matrix Fᵢᵢ is replaced by a matrix Gᵢᵢ, which is defined with formula (150) of Annex A. To calculate the matrix Gᵢᵢ, one first calculates the corresponding matrix Fᵢᵢ using formula (140), then applies formula (150).

In the current state of the research by the Applicants, formula (140) is preferred over formula (150), for stability reasons.

It is also possible to define the matrix F satisfying the filtering condition (130) by formula (160) combined with formula (170) of Annex A, which results from the deflation methods of linear algebra.

If formulas (80) and (90) are analyzed in combination with the conditions of formula (130) of annex A, it therefore appears that the calculation of M depends on the calculation of the matrices C and F, but the calculation of C can involve repeating the method or copying part of the matrix D, and that the components of the matrix F can be calculated independently, i.e., in parallel.

Several parallelization means therefore appear the execution of various interleaved loops can be done in parallel (for example, that of the block B1 and that of the block B2 of FIG. 4, and so forth with the blocks B11, B22, B33, B44, B55, B66 and B77 of FIG. 5), within a same loop, the calculations of the components of the matrix F can also be done in parallel, and for the calculation of the term S_{NN}, the calculations can also be done in parallel.

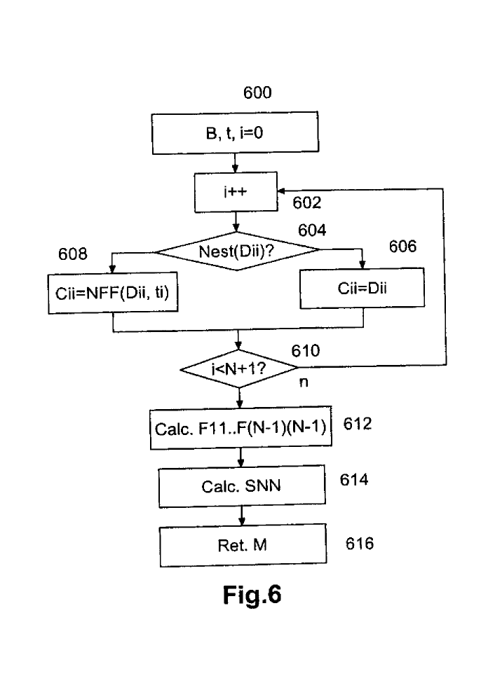

FIG. 6 provides an example of a function NFF( ) making it possible to calculate the pre-conditioner M. To that end, each term of the matrix is calculated, and assigned to the matrices C, F and S as appropriate.

In an operation 600, the function NFF( ) receives a matrix B and a filtering vector t as inputs, and uses, as parameters, a number N as the number of diagonal blocks in the matrix B, as well as an index i initialized at 0. As seen above, in the context of FIG. 3, the matrix B is the renumbered matrix A, which is used as input for the function NFF( ).

In the following, the words “element” or “term” must be understood as designating a block. In fact, the matrix B is pre-cut into rectangular blocks. Only the diagonal blocks of B must be square. The values of the sides of the blocks are defined by the respective dimensions of the diagonal blocks of the matrix B, and are given by the renumbering procedure of the matrix A.

Then, a first loop is executed so as to initiate all of the interleaved instances of the function NFF( ).

To that end, the index i is incremented, in an operation 602, then a function Nest( ) determines, in an operation 604, whether the corresponding diagonal block Dᵢᵢ has a form similar to that of formula (30) of Annex A. This defines a recursion condition.

When this is not the case, then the term Cᵢᵢ is defined as identical to the term Dᵢᵢ in an operation 606. When the term Dᵢᵢ has a form similar to that of formula (30) of Annex A, this means that the function NFF( ) can be used to calculate Cᵢᵢ, and the function NFF( ) is instanced again in an operation 608, with the block Dᵢᵢ and the sub-vector tᵢ as inputs.

Lastly, in an operation 610, a test verifies whether the index i is less than N+1. If it is, then the loop is reinitiated in 602. If not, the loop ends with the calculation of the elements of the matrix F and the matrix S.

It will be noted here that each call to the function NFF( ) in the operation 608 can be initiated by calling on a new processor or a new processor core, i.e., in parallel with the calculations related to the other calls for that function for other blocks. Furthermore, although the function described here is presented iteratively, the tests of the operation 604 on the N elements Dᵢᵢ can be done in parallel, as well as the operations 606 or 608 that follow those tests.

Once the loop is complete, and all of the instances of the function NFF( ) have been initialized, each of those instances calculates the (N−1) terms Fᵢᵢ where i varies between 1 and (N−1), using formula (140) of Annex A. If the second calculation mode is chosen, the calculation of Gᵢᵢ is also done, according to formula (150).

Here again, it will be noted that these calculations can be done in parallel, since they are independent of each other.

Once these terms are calculated, it remains only to calculate the term S_{NN} according to formula (180) of Annex A, in which the terms of the sum can here be calculated in parallel. For the terms S₁₁ to S_{(N-1)(N-1)}, the development of formula (90) shows that they are each equal to the term Cᵢᵢ with the same index.

Lastly, the matrix M that approximates the matrix B as input is returned as a result in an operation 616, in its decomposed form as in equation (80).

This is necessary to make it possible to perform the calculations in the higher order functions NFF( ). Thus, the deepest functions NFF( ) perform their calculations, then the results rise from layer to layer, up to the first instance, and the calculator-solver (12) is called.

It is advantageous to keep the matrix S calculated in each instance of the function NFF( ). In fact, the resolution of a system Mu=v can be done by using the decomposition of M according to formula (80) of Annex A, and by resolving two successive linear systems by substitution. Each block of M having been calculated interleaved can be resolved in the same way, which makes it possible to accelerate the calculation by interleaving the resolution of the linear systems.

In the preceding, the filtering condition is expressed by formula (20) of Annex A. This formula is a mathematical expression of the fact that the initial matrix A and the pre-conditioner M verify a stability condition that is based on the comparison of their product with a vector.

However, the stability condition must not be limited only to formula (20). Thus, the Applicants have also successfully used formula (190) of Annex A.

Since formula (190) is almost the transpose of formula (20), the use of formula (190) as stability condition does not change anything in the operating mode of the invention. Consequently, formulas (120) to (140) need only be slightly modified, as presented the formulas (200) to (220). Formulas (160) and (170) may be adapted similarly.

Further, all of the preceding examples have been done for a stability condition using a vector t.

However, when a physical system is modeled, many magnitudes are used. The experiments by the Applicants show that it is advantageous to use a stability condition using a matrix whereof each column concerns a physical property.

Thus, if two physical properties characterize a given formation of equations, it is advantageous to use, as filtering element t, a matrix having two columns. In practice, this does not change the philosophy of the invention, and the calculations previously presented are modified little or not at all.

In fact, in this type of situation, the equations represented in the matrix A will be associated by square “mini-blocks” whereof the side is equal to the number of columns of the matrix t. Therefore, in the case described in the previous paragraph, each mini-block would be a square block of two by two terms of the initial matrix A.

These mini-blocks are mentioned because they must not be separated during operation 320, and when the matrix A is divided into blocks. A given mini-block must always be contained in a single block of the matrix A or the matrix B.

The only element that slightly changes is the calculation of F. In fact, formula (140) of Annex A is adapted to a single-column matrix t, i.e., a vector, and the mini-blocks therefore are sized one by one, i.e., scalar.

The Applicants have therefore generalized formula (140) in the form of formula (230), in which Diag( ) designates a function that creates a diagonal matrix whereof the elements are designated in arguments of that function, and in which the operation “l” designates the term-by-term division of the matrices. Thus, A1/A2 is a matrix A3 whereof each term A3(i,j) is equal to the quotient of A1(i,j) by A2(i,j).

Another way to look at this modification is to note that formula (140) can be seen as a particular case of formula (230), in which t has a single column. Formula (220) may be modified identically.

In the preceding, the adapter 10, the calculator 12 and the driver 14 may be made in several ways.

First, the driver 14 may be made integrated with the adapter 10 and the calculator 12, i.e., these may be arranged to know how to interact, instead of being separate controlled elements that ignore each other.

Additionally, the presentation of the elements of the system 2 was primarily functional. Thus, these elements may be physically separated and connected by communication links, or implemented remotely over time, or implemented on the same piece of equipment with the driver 14 defined by the intrinsic connections between those elements and a user interface.

Furthermore, the discretizer 8, the adapter 10, the calculator 12 and the driver 14 can be implemented in the form of analogue elements, such as integrated circuits or daughterboards, or in the form of digital elements, i.e., in the form of programs implemented by a computer, optionally remotely and/or distributed.

It will also be noted that, in the preceding, reference is often indifferently made to matrices for the representation. It goes without saying that a computer does not know what a matrix is, and that it is indeed the digital representation of those matrices, i.e., the data that define those matrices, that are targeted. The terms matrix or matrix representation therefore refer to any digital data structure that makes it possible to process the matrix in the context of the invention.

Lastly, the particularly practical scope of examples of the device according to the invention makes it possible to simulate and resolve many physical problems that were not previously solvable, for example in the oil industry.

$$\begin{matrix}\underline{ANNEX A} \\ Ax = y & ( 10 ) \\ At = M t & ( 20 ) \\ A = [ \begin{matrix}{D}_{12} & & & {U}_{1 N} \\ & {D}_{22} & & {U}_{2 N} \\ & & ⋱ & ⋮ \\ {L}_{N 1} & {L}_{N 2} & & {D}_{NN}\end{matrix} ] & ( 30 ) \\ L = [ \begin{matrix}0 & & & \\ & ⋱ & & \\ ⋮ & ⋱ & ⋱ & \\ {L}_{N 1} & … & {L}_{NN - 1} & 0\end{matrix} ] & ( 40 ) \\ D = [ \begin{matrix}{D}_{11} & & & \\ & {D}_{22} & & \\ & & ⋱ & \\ & & & {D}_{NN}\end{matrix} ] & ( 50 ) \\ U = [ \begin{matrix}0 & & … & {U}_{1 N} \\ & ⋱ & ⋱ & ⋮ \\ & & ⋱ & {U}_{N - 1 N} \\ & & & 0\end{matrix} ] & ( 60 ) \\ A = ( L + T ) {T}^{- 1} ( U + T ) , \\ with T such that T = D - {LT}^{- 1} U & ( 70 ) \\ M = ( L + S ) {S}^{- 1} ( U + S ) & ( 80 ) \\ S = C - LFU & ( 90 ) \\ F = [ \begin{matrix}{F}_{11} & & & \\ & ⋱ & & \\ & & {F}_{( N - 1 ) ( N - 1 )} & \\ & & & 0\end{matrix} ] & ( 100 ) \\ C = [ \begin{matrix}{C}_{11} & & \\ & ⋱ & \\ & & {C}_{NN}\end{matrix} ] & ( 110 ) \\ \{ \begin{matrix}( {S}^{- 1} - F ) Ut = 0 \\ ( C - D ) t = 0\end{matrix} & ( 120 ) \\ \{ \begin{matrix}{C}_{ii} {t}_{i} = {D}_{ii} {t}_{i} & with i = 1 … N \\ {C}_{ii}^{- 1} {U}_{iN} {t}_{N} = {F}_{ii} {U}_{iN} {t}_{N} & with i = 1 … N - 1\end{matrix} & ( 130 ) \\ {F}_{ii} ( r , s ) = \{ \begin{matrix}( {C}_{ii}^{- 1} {U}_{iN} {t}_{N} ) ( r ) / ( {U}_{iN} {t}_{N} ) ( r ) & sir = set ( {U}_{iN} {t}_{N} ) ( r ) \neq 0 \\ ( {C}_{ii}^{- 1} {U}_{iN} {t}_{N} ) ( r ) / ( {U}_{iN} {t}_{N} ) ( s ) si ( {U}_{iN} {t}_{N} ) ( r ) = 0 with s such that & ( {U}_{iN} {t}_{N} ) ( s ) \neq 0 \\ 0 & if not\end{matrix} & ( 140 ) \\ {G}_{ii} = 2 {F}_{ii} - {F}_{ii} {C}_{ii} {F}_{ii} & ( 150 ) \\ {H}_{1} = {C}_{ii}^{- 1} {{Z}_{i} ( {Z}_{i}^{T} {Z}_{i} )}^{- 1} {Z}_{i}^{T} , \\ {Z}_{i} = {U}_{iN} {t}_{N} & ( 160 ) \\ {F}_{ii} = I - {C}_{ii} {H}_{i} + {H}_{i} & ( 170 ) \\ {S}_{NN} = {C}_{NN} - {\sum }_{i = 1}^{N - 1} {L}_{Ni} {F}_{ii} {U}_{iN} & ( 180 ) \\ {t}^{T} A = {t}^{T} M & ( 190 ) \\ \{ \begin{matrix}{t}^{T} L ( {S}^{- 1} - F ) = 0 \\ {t}^{T} ( C - D ) = 0\end{matrix} & ( 200 ) \\ \{ \begin{matrix}{t}_{i}^{T} {C}_{ii} = {t}_{i}^{T} {D}_{ii} & with i = 1 … N \\ {t}_{N}^{T} {L}_{Ni} {C}_{ii}^{- 1} = {t}_{N}^{T} {L}_{Ni} {F}_{ii} & with i = 1 … N - 1\end{matrix} & ( 210 ) \\ {F}_{ii} ( r , s ) = \{ \begin{matrix}( {t}_{N}^{T} {L}_{Ni} {C}_{ii}^{- 1} ) ( r ) / ( {t}_{N}^{T} {L}_{Ni} ) ( r ) & if r = s and ( {t}_{N}^{T} {L}_{Ni} ) ( r ) \neq 0 \\ ( {t}_{N}^{T} {L}_{Ni} {C}_{ii}^{- 1} ) ( s ) / ( {t}_{N}^{T} {L}_{Ni} ) ( r ) si ( {t}_{N}^{T} {L}_{Ni} ) ( s ) = 0 & with r such that ( {t}_{N}^{T} {L}_{Ni} ) ( r ) \neq 0 \\ 0 & if not\end{matrix} & ( 220 ) \\ {F}_{ii} ( r , s ) = \{ \begin{matrix}Diag ( ( {C}_{ii}^{- 1} {U}_{iN} {t}_{N} ) ( r ) / ( {U}_{iN} {t}_{N} ) ( r ) ) & if r = s and ( {U}_{iN} {t}_{N} ) ( r ) has no zero component \\ Diag ( ( {C}_{ii}^{- 1} {U}_{iN} {t}_{N} ) ( r ) / ( {U}_{iN} {t}_{N} ) ( s ) ) & if ( {U}_{iN} {t}_{N} ) ( r ) = 0 with s such that ( {U}_{iN} {t}_{N} ) ( s ) \neq 0 \\ 0 & if not\end{matrix} & ( 230 )\end{matrix}$$

1. A versatile calculation computer device of the type comprising:
a calculator-solver, receiving a working matrix representation and an initial matrix representation corresponding to a system of equations, as well as data of residues, and for providing a solution of the system of equations from data of residues,
an adapter, receiving an initial matrix representation corresponding to a system of equations to be processed, as well as a filtering matrix representation for this system of equations, and calculating a working matrix representation corresponding to a system of equations which may be solved by the calculator-solver,
wherein the working matrix representation being forced to verify, with the initial matrix representation, a stability condition comprising a comparison of two matrix products both including said filtering matrix representation or its transpose and respectively including the initial matrix representation and the working matrix representation,
wherein the adapter is configured to renumber the initial matrix representation and the filtering matrix representation to produce a modified matrix representation and a modified filtering matrix representation according to an ordering rule laid out so as to associate blocks of the matrix of the initial matrix representation as a function of a dependence condition, and recursively calculating the working matrix representation from the modified matrix representation and said modified filtering matrix representation,
wherein while the calculator-solver is configured to work recursively on the working matrix representation so as to provide a solution for the system of equations of the initial matrix representation, without complete inversion thereof,
wherein while said recursive calculation of the adapter comprises calculating the working matrix representation in the form of a matrix product PQR,
where P is the sum of a diagonal matrix calculated from an auxiliary matrix and an approximation matrix, and a block lower triangular matrix
wherein only the non-diagonal terms of the last raw of blocks are non-zero and are equal to the terms of the same index in the modified matrix representation,
where Q is the inverse of the diagonal matrix,
where R is the sum between the diagonal matrix and a block upper triangular matrix whereof only the non-diagonal terms of the last column of blocks are non-zero, and are equal to the terms of the same index in the modified matrix representation,
the auxiliary matrix being a block diagonal matrix, whereof each block with index i is:
defined equal to the diagonal block of index i (Dᵢᵢ) of the modified matrix representation when that block does not verify the recursion condition, and
otherwise calculated by a recursive call to the adapter with the diagonal block with index i (Dᵢᵢ) of the modified matrix representation as modified matrix representation and with a subset of the modified filtering matrix representation drawn from the index i (tᵢ) as modified filtering matrix representation,
the approximation matrix is a block diagonal matrix whereof the last block is zero, and whereof each non-zero block of index i is forced to verify, with the diagonal block of index i of the auxiliary matrix, an equivalence condition, comprising a comparison expression of two matrix products both respectively including said modified filtering matrix representation or its transpose and respectively a block of the block upper triangular matrix or a block of the block lower triangular matrix, and respectively including the inverse of said diagonal block with index i of the auxiliary matrix, and said block with index i of the approximation matrix,
the diagonal blocks of the diagonal matrix being equal to the blocks with the same index of the auxiliary matrix, except for the last one, which is defined as the difference between the last block of the auxiliary matrix the sum for a non-zero index k smaller than the number of diagonal blocks of the modified matrix representation of matrix products in form WXY, where W is the non-zero block of the k-th column of the block lower triangular matrix, X is the k-th block of the approximation matrix, and Y is the non-zero block of the k-th row of the block upper triangular matrix.

2. The device according to claim 1, wherein the stability condition comprises a comparison of two matrix products, both including said filtering matrix representation and respectively the initial matrix representation, and the working matrix representation, in which the equivalence condition comprises an expression for comparing two matrix products both including said modified filtering matrix representation and a block of the block upper triangular matrix, and respectively the inverse of said diagonal block with index i of the auxiliary matrix and said block with index i of the approximation matrix.

3. The device according to claim 1, wherein the stability condition comprises a comparison of two matrix products both including the transpose of said filtering matrix representation and respectively the initial matrix representation and the working matrix representation, and in which the equivalence condition comprises an expression for comparing two matrix products both including the transpose of said modified filtering matrix representation and a block of the block lower triangular matrix, and respectively the inverse of said diagonal block with index i of the auxiliary matrix and said block with index i of the approximation matrix.

4. The device according to claim 1, wherein the block with index i of the approximation matrix is calculated from a term-by-term division involving the inverse of said diagonal block with index i of the auxiliary matrix, and either the block with index i of the modified filtering matrix representation and the block with index i of the block upper triangular matrix, or the block with index i of the transpose of said modified filtering matrix representation and the block with index i of the block lower triangular matrix.

5. The device according to claim 1, wherein the approximation matrix is calculated by blocks using a deflation method, in which a first term (Zᵢ) involves the block with index N of the modified filtering matrix representation and the non-zero block of the i-th row of the block upper triangular matrix, in which a second term (Hᵢ) involves the block with index i of the auxiliary matrix and the first term, the block with index i of the approximation matrix being defined as the difference between the second term (Hi) and the matrix product of the block with index i of the auxiliary matrix with the second term (Hi), this difference being added to the identity matrix.

6. The device according to claim 1, wherein the filtering matrix representation is a column vector.

7. The device according to claim 1, also comprising a set of sensors, a digitizer, a discretizer and a driver, in which the driver is arranged to call the discretizer with data drawn from the digitizer that operates on data drawn from the sensor, to produce the initial matrix representation and the residual data, and laid out to control the adapter and the calculator-solver accordingly.

8. The device according to claim 1, wherein the system of equations represents a complex physical system of the real world, such as an oil field.

9. A versatile calculation method of the type comprising:
(a) receiving an initial matrix representation corresponding to a system of equations to be processed and a filtering matrix representation,
(b) calculating a working matrix representation verifying, with the initial matrix representation, a stability condition comprising an expression for comparing two matrix products both including said filtering matrix representation or its transpose, and respectively including the initial matrix representation and the working matrix representation,
(c) receiving data of residues, and solving the system of equations defined by the initial matrix representation, from the data of residues, the working matrix representation and the initial matrix representation,
wherein operation b) comprises:
b1) renumbering the initial matrix representation and the filtering matrix representation to produce a modified matrix representation and modified filtering matrix representation, and recursively calculating the working matrix representation from the modified matrix representation and the filtering representation,
b2) for each diagonal block of the modified matrix representation:
b2a) determining whether the current diagonal block of the modified matrix representation verifies a recursion condition,
b2b) if the recursion condition is verified, calculating a current block of an auxiliary matrix by reiterating the operation b) with the current diagonal block as modified matrix representation, and with a subset of the modified filtering matrix representation drawn from the index i (tᵢ) as modified filtering matrix representation,
b2c) if the recursion condition is not verified, defining the current block of the auxiliary matrix as equal to the current diagonal block,
b3) calculating blocks of a diagonal approximation matrix whereof each non-zero block with index i is forced to verify, with the diagonal block with index i of the auxiliary matrix, an equivalence condition, comprising a comparison expression of two matrix products both respectively including said modified filtering matrix representation or its transpose and respectively a block of a block upper triangular matrix or a block of a block lower triangular matrix, and respectively including the inverse of said diagonal block with index i of the auxiliary matrix, and said block with index i of the approximation matrix, said block upper triangular matrix and block lower triangular matrix being such that only the non-diagonal blocks of the last column and respectively of the last row are non-zero and defined equal to the corresponding blocks of the modified matrix representation,
b4) calculating a block diagonal matrix whereof the blocks are equal to the blocks of the same index of the auxiliary matrix, except for the last one, which is defined as the difference between the last block of the auxiliary matrix and the sum for a non-zero index k smaller than the number of diagonal blocks of the modified matrix representation of matrix products in form XYZ where X is the non-zero block of the k-th column of the block lower triangular matrix, Y is the k-th block of the approximation matrix, and Z is the non-zero block of the k-th row of the block upper triangular matrix, and
b5) calculating the working matrix representation from a matrix product whereof a first term is equal to the sum of the block lower triangular matrix and the matrix of operation b4), a second term is the inverse of the matrix of operation b4), and a third term is equal to the sum of the block upper triangular matrix and the matrix of operation b4),
and wherein the operation c) comprises working recursively on the working matrix representation so as to provide a solution for the system of equations of the initial matrix representation without complete inversion thereof.
